(19) United States
(12) Patent Application Publication
(10) Pub. No.: US 2026/0195042 A1
(43) Pub. Date: Jul. 9, 2026

(54) APPARATUS AND METHOD TO IMPROVE QUALITY OF SERVICE (QoS) IN A STORAGE DEVICE

(71) Applicant: Samsung Electronics Co., Ltd., Suwon-si (KR)

(72) Inventors: Srikanth TUMKUR SHIVANAND, Bengaluru (IN); Vishwas Pundalik BHAT, Bengaluru (IN); Sudhakara Yandrapu NAIDU, Bengaluru (IN); Niladri BHATTACHARYA, Bengaluru (IN); Ashok Chowdary GURRAM, Bengaluru (IN)

(73) Assignee: Samsung Electronics Co., Ltd., Suwon-si (KR)

(21) Appl. No.: 19/232,256

(22) Filed: Jun. 9, 2025

(30) Foreign Application Priority Data
Jan. 9, 2025 (IN) 202541002207
Mar. 18, 2025 (IN) 202541002207

(51) Int. Cl. G06F 3/06

(52) U.S. Cl. CPC G06F 3/0607; G06F 3/0629; G06F 3/0673

(57) ABSTRACT

An apparatus and a method for improving Quality of Service (QoS) in a storage device are provided. The method includes receiving read requests from at least one of a host and an internal process of the storage device; determining a first workload pattern for the storage device based on characteristics of the read requests; identifying a data placement technique used by the storage device and one or more workload patterns associated with the data placement technique; comparing the first workload pattern with the one or more workload patterns to determine whether the first workload pattern matches with the one or more workload patterns; and based on determining a mismatch between the first workload pattern and the one or more workload patterns, obtaining a second data placement technique by dynamically modifying the data placement technique of the storage device to improve the QoS.

### CROSS REFERENCE TO RELATED APPLICATIONS

This application claims priority to Indian Provisional Patent Application No. 202541002207, filed on Jan. 9, 2025, in the Indian Patent Office, and Indian Complete patent application No. 202541002207 filed on Mar. 18, 2025 in the Indian Patent Office, the disclosures of which are incorporated by reference herein in their entireties.

### BACKGROUND

The present disclosure generally relates to storage devices. More particularly, the present disclosure relates to apparatus and method for improving Quality of Service (QoS) in the storage devices by performing dynamic data placement in the storage devices.

In the related art, there exists a single striping method for data placement in storage devices, which limits the storage device's ability to adapt to diverse workload types and varying data patterns. Striping method in storage devices involves distributing the data across multiple storage units to maximize parallelism and improve performance of the storage device. However, the fixed striping method applies the same data distribution strategy regardless of the workload. For example, when the data arrives from the host, the data may vary in size commonly as 4 KB, 16 KB, 64 KB etc. A static striping method may not handle these varying data sizes coming from the host efficiently, potentially leading to suboptimal performance of the storage devices. Further, the static striping method for data placement restricts the storage device's ability to optimize for workloads with different data access patterns, such as sequential reads or random writes, as small random writes and large sequential writes have different requirements, and a one-size-fits-all data placement approach often fails to cater to both effectively.

Thus, the static striping method provides significant advantages for only one workload type but is not universally optimal, highlighting the need for dynamic data placement to cater to diverse workload demands in storage devices. Hence there is a need to select the best striping method for a particular workload to improve the QoS of the storage devices.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

This summary is provided to introduce a selection of concepts, in a simplified format, which is further described in the detailed description of the disclosure. This summary is neither intended to identify key or essential concepts of the disclosure nor is it intended for determining the scope of the disclosure.

According to an aspect of the disclosure, a method of improving Quality of Service (QoS) in a storage device, includes: receiving a plurality of read requests from at least one of a host and an internal process of the storage device; determining a first workload pattern for the storage device based on characteristics of the plurality of read requests, wherein the characteristics include at least one of a request frequency, an access locality, and a data size; identifying a data placement technique used by the storage device and one or more workload patterns associated with the data placement technique; comparing the first workload pattern with the one or more workload patterns to determine whether the first workload pattern matches with the one or more workload patterns; and based on determining a mismatch between the first workload pattern and the one or more workload patterns, obtaining a second data placement technique by dynamically modifying the data placement technique of the storage device to improve the QoS.

According to an aspect of the disclosure, an apparatus to improve Quality of Service (QoS) in a storage device by performing dynamic data placement in the storage device, includes: at least one processor, wherein the at least one processor is configured to: receive a plurality of read requests from at least one of a host and an internal process of the storage device, determine a first workload pattern for the storage device based on characteristics of the plurality of read requests, wherein the characteristics include at least one of request frequency, access locality, and data size, identify a data placement technique used by the storage device and one or more workload patterns associated with the data placement technique, compare the first workload pattern with the one or more workload patterns to determine whether the first workload pattern matches with the one or more workload patterns, and based on determining mismatch between the first workload pattern and the one or more workload patterns of the data placement technique, obtain a second data placement technique by dynamically modifying the data placement technique of the storage device.

According to an aspect of the disclosure, a non-transitory computer readable medium stores instructions that are executable by at least one processor to perform a method of improving Quality of Service (QoS) in a storage device, the method including: receiving a plurality of read requests from a host or an internal process of the storage device; determining a first workload pattern for the storage device based on characteristics of the plurality of read requests, wherein the characteristics include at least one of request frequency, access locality, and data size; identifying a data placement technique used by the storage device and one or more workload patterns associated with the data placement technique; comparing the first workload pattern with the one or more workload patterns to determine whether the first workload pattern matches with the one or more workload patterns; and based on determining mismatch between the first workload pattern and the one or more workload patterns of the data placement technique, obtaining a second data placement technique by modifying the data placement technique of the storage device.

### BRIEF DESCRIPTION OF THE DRAWINGS

The above and/or other aspects of the disclosure will be apparent from the following description take in conjunction with the accompanying drawings, in which:

FIG. 1 illustrates a block diagram of an apparatus to improve Quality of Service (QoS) in a storage device, in accordance with an embodiment of the present disclosure;

FIG. 2 illustrates an exemplary environment to improve QoS in the storage device by performing dynamic data placement in the storage device, in accordance with the embodiments of the present disclosure;

FIG. 3 illustrates a sequence flow chart illustrating dynamic data placement in the storage device by the host, in accordance with the embodiments of the present disclosure; and

FIG. 4 illustrates a sequence flow of a method for improving Quality of Service (QoS) in the storage device by performing dynamic data placement in the storage device, in accordance with an embodiment of the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises,” “comprising,” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. The present disclosure discloses apparatus and method for improving Quality of Service (QoS) in a storage device by performing dynamic data placement in the storage device, which shall now be discussed in the subsequent paragraphs.

The present disclosure provides for dynamic data placement or the ability to switch between different striping methods based on the workload demands. The apparatus of the present disclosure analyses the nature of the incoming workload and adjusts the data placement in the storage device, leading to improved QoS of the storage device. Additionally, in an embodiment of the present disclosure, the host may also decide the striping method based on the detected workload pattern to ensure optimal performance for a wide range of workloads, enhancing the overall increased in performance of the storage device.

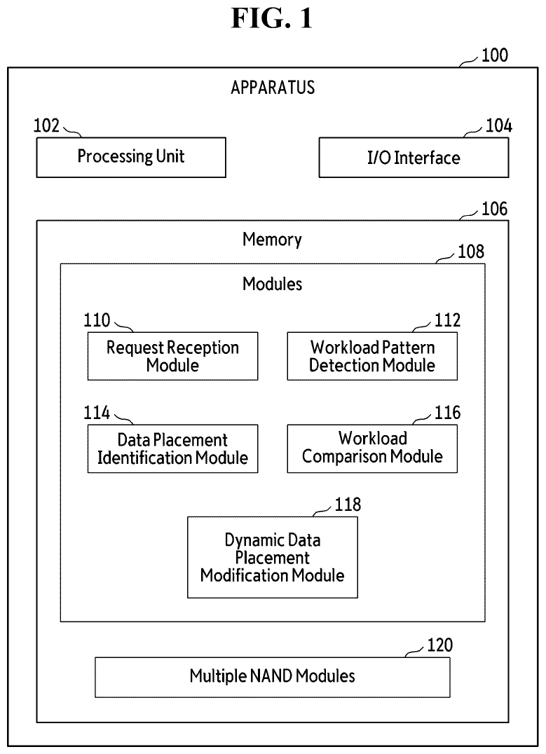

FIG. 1 illustrates a block diagram of an apparatus 100 to improve QoS in the storage device by performing dynamic data placement in the storage device, in accordance with an embodiment of the present disclosure. The apparatus 100 may comprise a processing unit 102 comprising at least one processor, an input/output (I/O) interface 104, and a memory 106, but not limited thereto. The processing unit 102 may comprise at least one data processor for executing program components for executing user or system-generated business processes. The processing unit 102 may comprise specialized processing units such as integrated system (bus) controllers, memory management control units, floating point units, graphics processing units, digital signal processing units, etc.

The processing unit 102 may be disposed in communication with one or more input/output (I/O) devices via I/O interface 104. The I/O interface 104 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 104, the apparatus 100 may communicate with one or more I/O devices.

The apparatus 100 may also include suitable logic, circuitry, and interfaces that may be configured to provide the process visualization and the simulated training. In an embodiment, the apparatus 100 may be implemented in a computing device. A person skilled in the art may appreciate that the computing device may be a smartphone, a cellular phone, a mobile phone, a mainframe machine, a computer workstation, a laptop and/or a consumer electronic (CE) device.

The memory 106 may be processed by modules 108 of the apparatus 100. The modules 108 may be stored within the memory 106 as shown in FIG. 1. As an example, modules 108, communicatively coupled to the processing unit 102, may also be present outside the memory 106.

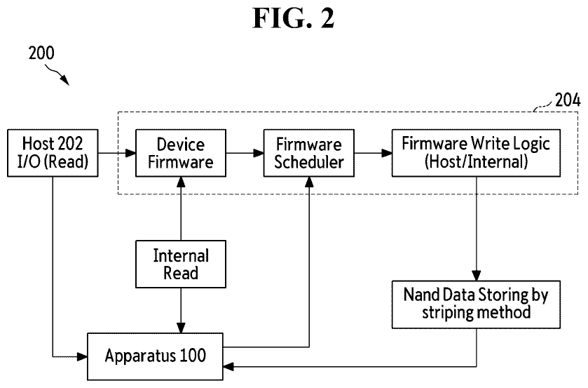

In one implementation, the modules 108 may comprise, for example, a request reception module 110, a workload pattern detection module 112, a data placement identification module 114, a workload comparison module 116, a dynamic data placement modification module 118 and multiple NAND modules 120. The multiple NAND modules 120 may be NAND parallel units which may be used to perform various miscellaneous functionalities of the apparatus 100. In an embodiment of the present disclosure, the dynamic data placement may be among the multiple NAND modules 120. It will be appreciated that such aforementioned modules may be represented as a single module or a combination of different modules. The modules may be implemented in any suitable hardware, software, firmware, or combination thereof. Further the modules 108 may be implemented by various techniques comprising but not limited to computer programs, one or more neural networks, machine learning algorithms, embedded systems design and cloud computing architectures. The implementation of the various modules 108 to improve QoS in the storage device shall now be explained in subsequent paragraphs by referring to FIGS. 2-4.

FIG. 2 illustrates an exemplary environment 200 to improve QoS in the storage device by performing dynamic data placement in the storage device, in accordance with the embodiments of the present disclosure. In an embodiment, the request reception module 110 of the apparatus 100 may receive a plurality of read requests from at least one of a host 202 and internal processes of the storage device 204, as shown in FIG. 2. The plurality of read requests comprises host read requests and/or internal read requests of the storage device 204. Host read requests refer to the data access requests originating from external systems such as a computing device, server, or embedded system. A person skilled in the art may appreciate that the computing device may be a smartphone, a cellular phone, a mobile phone, a mainframe machine, a computer workstation, a laptop and/or a consumer electronic (CE) device. On the other hand, internal read requests comes from processes running within the storage device 204 itself. These requests involve tasks such as background operations for data maintenance, such as garbage collection (GC), Patrol read, Read intensive cleaning (RINC), Wear Levelling.

In an embodiment, the workload pattern detection module 112 of the apparatus 100 may determine a workload pattern for the storage device 204 based on characteristics of the received plurality of read requests. The characteristics include at least one of request frequency, access locality, and data size. The workload pattern detection module 112 monitors the Logical Page Numbers (LPNs) and their corresponding Virtual Page Numbers (VPNs) for all read operations, tracking the specific channel, bank, and plane to which they are directed.

In an embodiment, the data placement identification module 114 of the apparatus 100 may identify a data placement technique used by the storage device 204 and one or more workload patterns associated with the data placement technique. Further, the data placement identification module 114 may identify an optimal data placement technique for the storage device 204 by comparing the determined workload pattern with a reference table. The reference table comprises a plurality of data placement techniques and corresponding one or more workload patterns. In an embodiment of the present disclosure, the reference table is generated by monitoring performance of the storage device 204 for a plurality of workload patterns and all possible combination of the data placement technique during initial boot up of the storage device 204. Considering a storage device with maximum 4 channels per core, there may be a maximum of three types of striping:
Type-1 (4LPN for channel-bank-plane),
Type-2 (2LPN for channel-bank-plane), and
Type-3 (1LPN for channel-bank-plane).

Table-1 below depicts the best-case performance estimate for the above mentioned striping.

Table 1 showing an example reference table generated for standard read workloads.

TABLE 1

| Data placement | | |
|---|---|---|
| striping type | Random Read (RR) | Sequential Read (SR) |
| Type-1 | Bigger Chunk | Bigger Chunk |
| | (greater than 256 KB) | (greater than 256 KB) |
| | Higher Que Depth (QD) | Higher Que Depth (QD) |
| Type-2 | Smaller Chunk | Smaller Chunk |
| | (up to 256 KB) | (up to 256 KB) |
| | Lower QD | Lower QD |
| Type-3 | Smallest Chunk | Smallest Chunk |
| | (up to 64 KB) | (up to 64 KB) |
| | Lowest QD | Lowest QD |

The data placement identification module 114 of the apparatus 100 may then identify the different ranges of host workload patterns, as depicted in Table 1, that are best suited for each striping method. Based on the type of workload or the specific striping method requested by the host, the appropriate data placement type will be identified and set accordingly by the data placement identification module 114. In an embodiment of the present disclosure, the storage device 204 starts with a default striping method.

Further in an embodiment of the present disclosure, Table-2 below depicts an example of concurrent mapping of data striping type maintained in the storage device based on the different NameSpaces (NS) of the host configuration or the workload detection by the workload pattern detection module 112. However, the current mapping of the data striping type in the storage device is not static and may be modified as and when needed.

TABLE 2

| NameSpace/Stream ID | Data placement striping type |
|---|---|
| NS-1 | 2 |
| NS-2 | 1 |
| NS-3 | 3 |

Referring again to FIG. 2, the workload comparison module 116 of the apparatus 100 may further compare the determined workload pattern with the one or more workload patterns associated with the identified data placement technique to determine whether the determined workload pattern matches with the one or more workload patterns. If the workload comparison module 116 detects a mismatch, it then generates an interrupt service routine (ISR) and sets a register of the storage device 204 to specify the priority type and the data placement logic to be used thereafter, based on the workload comparison.

In an embodiment, the dynamic data placement modification module 118 of the apparatus 100 may dynamically modify the data placement technique of the storage device 204 to improve the QoS, upon determining mismatch between the determined workload pattern and the one or more workload patterns of current data placement technique. This dynamic data placement modification module 118 may further perform subsequent write operations in the storage device 204 based on the modified data placement technique and/or modify storage of existing data by relocating data blocks in the storage device based on the modified data placement technique. The data placement modification shall be applied over the existing data over a period of time, and the internal writes will also adhere to the same data placement. Hence after a modification is made by the dynamic data placement modification module 118, the internal jobs like GC, Patrol read, RINC, Wear Leveling will all be utilizing the same data placement.

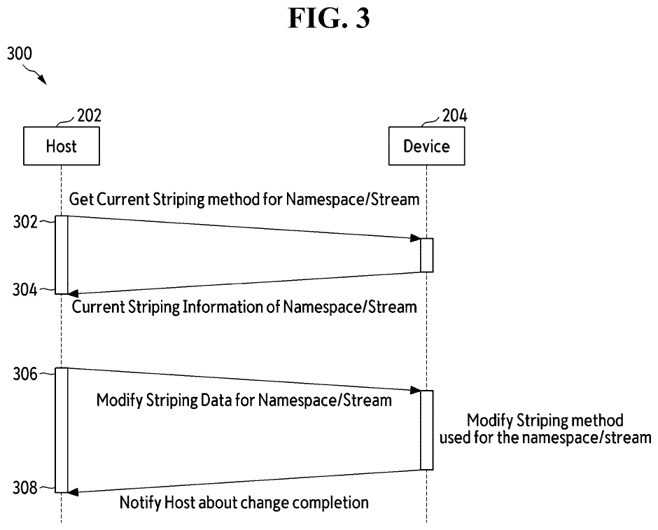

FIG. 3 illustrates a sequence flow chart 300 illustrating dynamic data placement in the storage device 204 by the host 202, in accordance with the embodiments of the present disclosure. In an embodiment of the present disclosure, the host 202 may also may also decide the striping method for dynamic data placement based on the workload applicable for a namespace of the storage device to ensure optimal performance of the storage device, as explained in subsequent steps.

At step 302, the step comprises inquiring by the host 202 the current striping method for Namespace from the storage device 204. Further, step 304 may comprise sending by the storage device 204 the current striping information of Namespace to the host 202. After receiving the current striping information from the storage device 204, step 306 may comprise modifying the striping method of data placement of the storage device 204 by the host 202. Finally, step 308 may comprise notifying the change in the data placement to the host 202 by the storage device 204.

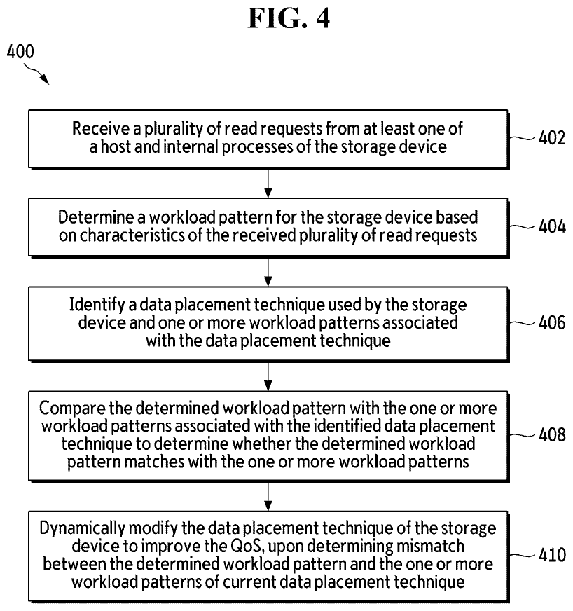

FIG. 4 illustrates a sequence flow of a method 400 for improving Quality of Service (QoS) in the storage device by performing dynamic data placement in the storage device, in accordance with an embodiment of the present disclosure.

At step 402, the method comprises receiving by the request reception module 110, a plurality of read requests from at least one of a host 202 and internal processes of the storage device 204. The plurality of read requests comprises host read requests and/or internal read requests of the storage device 204. Host read requests refer to the data access requests originating from external systems such as a computing device, server, or embedded system. A person skilled in the art may appreciate that the computing device may be a smartphone, a cellular phone, a mobile phone, a mainframe machine, a computer workstation, a laptop and/or a consumer electronic (CE) device. On the other hand, internal read requests come from processes running within the storage device 204 itself. These requests involve tasks such as background operations for data maintenance, such as garbage collection (GC), Patrol read, RINC, and Wear Levelling.

At step 404, the method comprises determining by the workload pattern detection module 112, a workload pattern for the storage device 204 based on characteristics of the received plurality of read requests. The characteristics include at least one of request frequency, access locality, and data size. The workload pattern detection module 112 monitors the Logical Page Numbers (LPNs) and their corresponding Virtual Page Numbers (VPNs) for all read operations, tracking the specific channel, bank, and plane to which they are directed.

At step 406, the method comprises identifying by the data placement identification module 114, a data placement technique used by the storage device 204 and one or more workload patterns associated with the data placement technique. Further, the data placement identification module 114 may identify an optimal data placement technique for the storage device 204 by comparing the determined workload pattern with a reference table. The reference table comprises a plurality of data placement techniques and corresponding one or more workload patterns as depicted in Table 1 and the same is not repeated for the sake of brevity. Furthermore, in an embodiment of the present disclosure, Table 2 as illustrated above depicts an example of concurrent mapping of data striping type maintained in the storage device 204 based on the different NameSpaces (NS) of the host configuration or the workload detection by the workload pattern detection module 112. However, the current mapping of the data striping type in the storage device 204 is not static and may be modified as and when needed.

At step 408, the method comprises comparing by the workload comparison module 116, the determined workload pattern with the one or more workload patterns associated with the identified data placement technique to determine whether the determined workload pattern matches with the one or more workload patterns. If the workload comparison module 116 detects a mismatch, it then generates an interrupt service routine (ISR) and sets a register of the storage device 204 to specify the priority type and the data placement logic to be used thereafter, based on the workload comparison.

At step 410, the method comprises dynamically modifying by the dynamic data placement modification module 118, the data placement technique of the storage device 204 to improve the QoS, upon determining mismatch between the determined workload pattern and the one or more workload patterns of current data placement technique. This dynamic data placement modification module 118 may further perform subsequent write operations in the storage device 204 based on the modified data placement technique and/or modify storage of existing data by relocating data blocks in the storage device based on the modified data placement technique. The data placement modification shall be applied over the existing data over a period of time, and the internal writes will also adhere to the same data placement. Hence after a modification is made by the dynamic data placement modification module 118, the internal jobs like GC, Patrol read, RINC, Wear Leveling will all be utilizing the same data placement.

The order in which the flowchart 400 is described is not intended to be construed as a limitation, and any number of the described method blocks can be combined in any order to implement the flowchart 400 or alternate methods. Additionally, individual blocks may be deleted from the flowchart 400 without departing from the spirit and scope of the subject matter described herein. Furthermore, the method 400 can be implemented in any suitable hardware, software, firmware, or combination thereof. It may be noted here that the subject matter of some or all embodiments described with reference to FIGS. 1-3 and Tables 1-2 may be relevant for the methods and the same is not repeated for the sake of brevity.

In conclusion, the present disclosure demonstrates that by dynamically modifying the data placement in response to workload patterns to choose best striping method results in significant performance improvements in the storage device 204. Specifically, the implementation of the described techniques achieved at least 37% enhancement in overall random read performance, showcasing the effectiveness of dynamic data placement in improving the Quality of Service (QoS) in storage devices.

Embodiments of the disclosure can also be embodied as a non-transitory computer readable medium storing instructions executable by a processor or a computer such as a program module executed by the computer. The non-transitory computer-readable medium refers to a medium that stores data semi-permanently and can be read by a device.

The illustrated steps are set out to explain the exemplary embodiments shown, and it may be anticipated that ongoing technological development will change the way particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

The foregoing method descriptions and the process flow diagrams are provided merely as illustrative examples and are not intended to require or imply that the steps of the various embodiments must be performed in the order presented. As may be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

Various embodiments are described with reference to the accompanying drawings, in which some, but not all embodiments are shown. These embodiments are provided so that this disclosure may satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the feature, structure, or characteristic following the phrase may be included in at least one embodiment of the present disclosure and may be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can,” “may,” “could,” “should,” “would,” “preferably,” “possibly,” “typically,” “optionally,” “for example,” “often,” or “might” (or other such language) be included or have a characteristic, that component or feature is not required to be included or to have the characteristic. Such component or feature may be optionally included in some embodiments, or it may be excluded.

In some example embodiments, certain ones of the operations herein may be modified or further amplified as described below. Moreover, in some embodiments additional optional operations may also be included. It should be appreciated that each of the modifications, optional additions or amplifications described herein may be included with the operations herein either alone or in combination with any others among the features described herein.

Many modifications and other embodiments of the disclosure set forth herein will come to mind to one skilled in the art as having the benefit of teachings presented in the foregoing descriptions and the associated drawings. Although the figures only show certain components of the apparatus and systems described herein, it is understood that various other components may be used in conjunction with the supply management system. Therefore, the claims are not limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

What is claimed is:

1. A method of improving Quality of Service (QoS) in a storage device, the method comprising:
receiving a plurality of read requests from at least one of a host and an internal process of the storage device;
determining a first workload pattern for the storage device based on characteristics of the plurality of read requests, wherein the characteristics include at least one of a request frequency, an access locality, and a data size;
identifying a data placement technique used by the storage device and one or more workload patterns associated with the data placement technique;
comparing the first workload pattern with the one or more workload patterns to determine whether the first workload pattern matches with the one or more workload patterns; and
based on determining a mismatch between the first workload pattern and the one or more workload patterns, obtaining a second data placement technique by dynamically modifying the data placement technique of the storage device to improve the QoS.

2. The method of claim 1, wherein the dynamically modifying the data placement technique of the storage device comprises:
identifying an optimal data placement technique for the storage device by comparing the first workload pattern with a reference table, and
wherein the reference table comprises a plurality of data placement techniques and one or more respective workload patterns corresponding to the plurality of data placement techniques.

3. The method of claim 1, further comprising at least one of:
performing subsequent write operations in the storage device based on the second data placement technique; and
modifying storage of existing data by relocating data blocks in the storage device based on the second data placement technique.

4. The method of claim 1, wherein the plurality of read requests comprises at least one of host read requests and internal read requests of the storage device.

5. The method of claim 2, wherein the reference table is generated by monitoring performance of the storage device for a plurality of workload patterns and possible combinations of the data placement technique during initial boot up of the storage device.

6. The method of claim 1, further comprises:
dynamically modifying the data placement technique of the storage device by the host, based on the first workload pattern.

7. An apparatus to improve Quality of Service (QoS) in a storage device by performing dynamic data placement in the storage device, the apparatus comprising:
at least one processor,
wherein the at least one processor is configured to:
receive a plurality of read requests from at least one of a host and an internal process of the storage device,
determine a first workload pattern for the storage device based on characteristics of the plurality of read requests, wherein the characteristics comprise at least one of request frequency, access locality, and data size,
identify a data placement technique used by the storage device and one or more workload patterns associated with the data placement technique,
compare the first workload pattern with the one or more workload patterns to determine whether the first workload pattern matches with the one or more workload patterns, and
based on determining mismatch between the first workload pattern and the one or more workload patterns of the data placement technique, obtain a second data placement technique by dynamically modifying the data placement technique of the storage device.

8. The apparatus of claim 7, wherein to dynamically modify the data placement technique of the storage device, the at least one processor is further configured to:
identify an optimal data placement technique for the storage device by comparing the first workload pattern with a reference table, and
wherein the reference table comprises a plurality of data placement techniques and one or more workload patterns corresponding to the plurality of data placement techniques.

9. The apparatus of claim 7, wherein the at least one processor is further configured to perform at least one of:
perform subsequent write operations in the storage device based on the second data placement technique; and
modify storage of existing data by relocating data blocks in the storage device based on the second data placement technique.

10. The apparatus of claim 7, wherein the plurality of read requests comprises at least one of host read requests and internal read requests of the storage device.

11. The apparatus of claim 8, wherein the reference table is generated by monitoring performance of the storage device for a plurality of workload patterns and possible combination of the data placement technique during initial boot up of the storage device.

12. The apparatus of claim 7, wherein the at least one processor is further configured to:
dynamically modify the data placement technique of the storage device by the host, based on the first workload pattern.

13. A non-transitory computer readable medium storing instructions that are executable by at least one processor to perform a method of improving Quality of Service (QoS) in a storage device, the method comprising:
receiving a plurality of read requests from a host or an internal process of the storage device;
determining a first workload pattern for the storage device based on characteristics of the plurality of read requests, wherein the characteristics include at least one of request frequency, access locality, and data size;
identifying a data placement technique used by the storage device and one or more workload patterns associated with the data placement technique;
comparing the first workload pattern with the one or more workload patterns to determine whether the first workload pattern matches with the one or more workload patterns; and
based on determining mismatch between the first workload pattern and the one or more workload patterns of the data placement technique, obtaining a second data placement technique by modifying the data placement technique of the storage device.

14. The non-transitory computer readable medium of claim 13, wherein the dynamically modifying the data placement technique of the storage device comprises:
identifying an optimal data placement technique for the storage device by comparing the first workload pattern with a reference table, and
wherein the reference table comprises a plurality of data placement techniques and one or more respective workload patterns corresponding to the plurality of data placement techniques.

15. The non-transitory computer readable medium of claim 13, wherein the method further comprises at least one of:
performing subsequent write operations in the storage device based on the second data placement technique; and
modifying storage of existing data by relocating data blocks in the storage device based on the second data placement technique.

16. The non-transitory computer readable medium of claim 13, wherein the plurality of read requests comprises at least one of host read requests of the storage device and internal read requests of the storage device.

17. The non-transitory computer readable medium of claim 14, wherein the reference table is generated by monitoring performance of the storage device for a plurality of workload patterns and possible combinations of the data placement technique during initial boot up of the storage device.

18. The non-transitory computer readable medium of claim 13, wherein further comprises:
dynamically modifying the data placement technique of the storage device by the host, based on the first workload pattern.
